(19) United States
(12) Patent Application Publication
(10) Pub. No.: US 2008/0133133 A1
(43) Pub. Date: Jun. 5, 2008

(54) System and method of enabling features based on geographic imposed rules

(76) Inventor: Steven M. Abels, Carmel, IN (US)

Correspondence Address: DELPHI TECHNOLOGIES, INC., M/C 480-410-202, PO BOX 5052, TROY, MI, 48007, US

(21) Appl. No.: 11/633,157

(22) Filed: Dec. 4, 2006

(51) Int. Cl. G01C 21/00

(52) U.S. Cl. 701/213; 701/207; 340/995.1

(57) ABSTRACT

A dual-view display system and method are provided for use on a vehicle to display first and second viewing windows to a driver and a passenger in a vehicle. The display system stores acquired regulations for operating a display based on geographic location, and employs a position determining device to determine the position of the display. The display system further includes a controller for retrieving regulations pertaining to the determined geographic location and controls one or more features of the display based on the determined geographic location such that the display system may operate in compliance with geographically imposed regulations.

### TECHNICAL FIELD

The present invention generally relates to electronic systems and, more particularly, relates to controlling an electronics device, such as a display, in compliance with rules such as regulations.

### BACKGROUND OF THE INVENTION

Automotive vehicles are frequency equipped with various electronic entertainment and information systems and mobile multimedia devices, generally referred to herein as infotainment systems. Infotainment systems generally include automotive personal computing devices installed in vehicles to allow personal computing, web browsing, accessing e-mail, and other Internet access. Additionally, infotainment systems include navigation systems, DVDs, televisions and video game systems. These and other infotainment systems typically include a human machine interface (HMI) for enabling the user to interface with the system. The HMI typically includes a display for viewing messages, navigational maps, video images and other information. The HMI also includes input controls for allowing manipulation by a user to input commands to the infotainment system.

Recently, dual-view displays have been developed and proposed for use on vehicles to allow two different image contents to be displayed on the same physical display. The two different display images are typically viewable from either the left side in the left or driver viewing window or the right side in the right or passenger viewing window. The dual-view display for use in an infotainment system in a vehicle allows the driver of the vehicle to view limited image content when the vehicle is moving, such as navigational and other driver relevant content, while allowing a non-driving passenger to view different display images, such as movies, games, Internet output and other image content. Thus, the driver of the vehicle may not be distracted by image content that is not relevant to driving, while at the same time allowing the passenger to view other image content.

Regulations such as state and federal laws may prohibit the use of certain electronic devices, such as dual-view displays, based on potential driver activity. For example, a number of state governments have prohibited the display of video forward of the driver's seat, whereas other state governments allow video forward of the driver's seat as long as the video cannot be visible from the driver's seat or vantage point. As a result of the varying legislation, certain electronic devices, such as dual-view displays, may be prohibited in some states and acceptable in other states. As a consequence, the variances in legislation creates a potential problem when traveling from one regulated geographic region (e.g., state) to another differently regulated geographic region.

Accordingly, it is therefore desirable to provide for control of electronic devices, such as a display or more particularly a dual-view display that allows for compliance of regulations, such that users may achieve optimal use of the technology. It is further desirable to provide for controlled use of a dual-view display in a vehicle that allows occupants in the vehicle to view the image content in compliance with regulations that may be imposed in various geographic jurisdictions.

### SUMMARY OF THE INVENTION

In accordance with the teachings of the present invention, a system and method are provided for controlling an electronic device to ensure compliance with rules, such as regulations. According to one aspect of the present invention, a system is provided having an electronic device operable to provide one or more features. The system includes a device for acquiring rules pertaining to use of the electronic device based on geographic region. The system also includes a position determining device for determining location of the electronic device, and a controller for controlling the electronic device. The controller looks up regulations pertaining to the determined geographic location and controls one or more features of the electronic device based on the rules pertaining to the determined geographic location.

According to another aspect of the present invention, a display system is provided having a display located in a vehicle for presenting an image having image content that is viewable within a viewing window. The display system has a device for acquiring rules pertaining to use of the display based on geographic regions. The display system also has a position determining device for determining position of the display. The display system further has a controller for controlling the display. The controller retrieves rules pertaining to the determined geographic location and controls one or more display features based on the rule pertaining to the determined geographic location.

According to a further aspect of the present invention, a method of presenting one or more features, such as display images to one or more users, based on regulations imposed in geographic locations is provided. The method includes the step of providing an electronic device, such as a display, operable to provide one or more features. The method also includes the steps of storing in memory rules pertaining to use of the electronic device based on geographic regions, and determining a geographic position of the display. The method further includes the steps of selecting rules that pertain to the determined geographic location and controlling one or more display features based on the selected rules pertaining to the determined geographic location. According to a further aspect of the present invention, the electronic device is a display located onboard a vehicle.

The electronics system, such as a display system, and method of the present invention advantageously allow for controlled use of an electronic device, particularly for use on a mobile vehicle to ensure that the device is usable and in compliance with rules, such as government imposed regulations, that vary from one geographic jurisdiction to another. The system and method are particularly well-suited for use on a vehicle to allow for enhanced legal use of an electronic device, such as a display by passenger occupants within the vehicle, while prohibiting distractive and illegal use.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a forward view of a vehicle passenger compartment having an infotainment system equipped with a display system, according to one embodiment of the present invention;

FIG. 2 is a left side front view of the infotainment system displaying image content seen by the driver of the vehicle;

FIG. 3 is a right side front view of the infotainment system displaying image content seen by a passenger in the vehicle;

FIG. 4 is a right side front view of the infotainment system displaying image content seen by the passenger when regulations prohibit viewing;

FIG. 5 is a block diagram illustrating the display system with controls for controlling geographically regulated content, according to one embodiment of the present invention;

FIG. 6 is an exploded view of the dual-view display, according to one embodiment;

FIG. 7 is a map illustrating geographic jurisdictions within the North America continent that may have varying regulations imposed on the display, according to one embodiment; and

FIG. 8 is a flow diagram illustrating a method of controlling use of the dual-view display in compliance with geographic imposed regulations, according to one embodiment.

### DESCRIPTION OF THE PREFERRED EMBODIMENTS

The present invention is described in connection with an electronics system that provides one or more features in compliance with rules, such as government imposed regulations, based on geographic location. In the embodiment shown and described herein, the electronics system is a display system having a dual-view display located in a vehicle for providing dual-display of images, with one image viewable by the driver and one image viewable by a passenger. One or more features of the dual-display are controlled based on geographic location so as to conform to geographic based regulations. However, it should be appreciated that other electronic systems may be controlled based upon the geographic locations and rules imposed in such geographic locations.

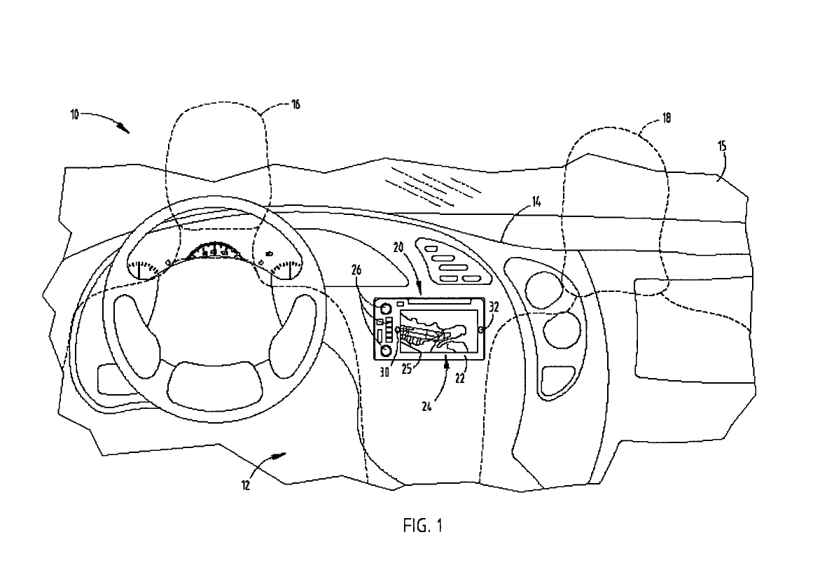

Referring to FIG. 1, the front passenger compartment 12 of a vehicle 10 is generally illustrated showing a driver 16 seated in a driver seat and a front passenger 18 seated in a passenger seat in the vehicle 10. The passenger compartment 12 generally includes a dash 14 with various conventional devices, such as an instrument cluster located at the front of the passenger compartment, forward of the steering wheel and steering column. The dash 14 extends in front of both the driver 16 and front passenger 18 and is located below the front windshield 15.

Centrally mounted within the dash 14 in the front side of the passenger compartment is an electronic infotainment system 20 which is readily accessible to both a first user shown as the driver 16 of the vehicle 10 on the left side and a second user shown as the front passenger 18 on the right side. The infotainment system 20 is an electronic system which generally includes any of a variety of information, entertainment and multimedia systems commonly known in the art. For example, the infotainment system 20 may include any one or a combination of the following systems: an automotive personal computing device, a web browser, an Internet access device, a satellite communication system, a mobile multimedia system, a radio, a television, a DVD player, a video game player, a navigation system, a phone/address book lookup system, a rear or side obstruction system, a vehicle information and control system, and other types of electronic devices and systems.

The infotainment system 20 includes a human machine interface (HMI) for allowing occupants, including the driver 16 and front passenger 18 to interface with the infotainment system 20. The HMI includes a display system 24 for displaying images, including video images, maps, menus, text messages, and other content viewable within first and second viewing windows, according to one embodiment. The display system 24 is mounted to a housing 22. The display system 24 has a dual-image display 25 that generates a first image readily viewable by the driver 16 on the left side in a first viewing window, and simultaneously generates a second image readily viewable by the front passenger 18 on the right side in a second different viewing window. However, the display system 24 may include a display 25 providing any of a number of a plurality of viewing windows for generating image content that is viewable within the viewing windows and may vary from the image content of other viewing windows.

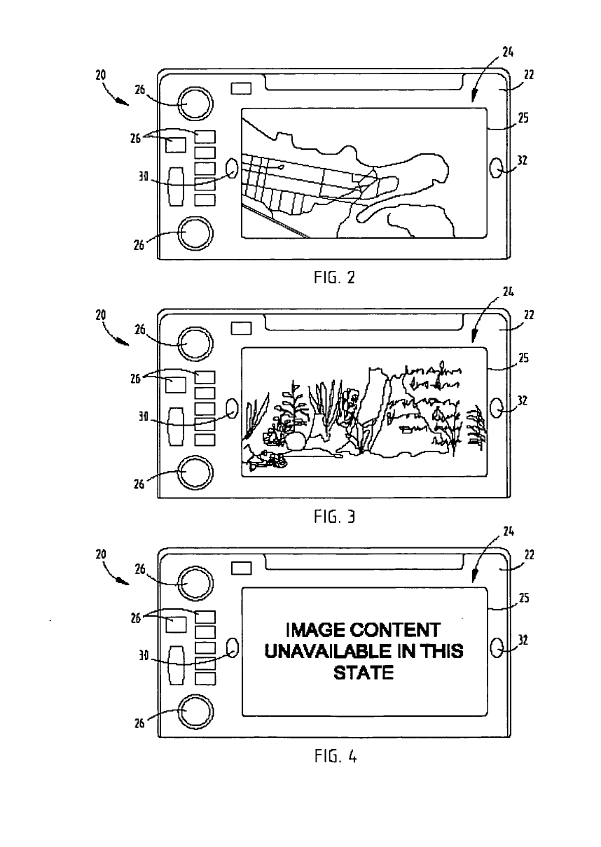

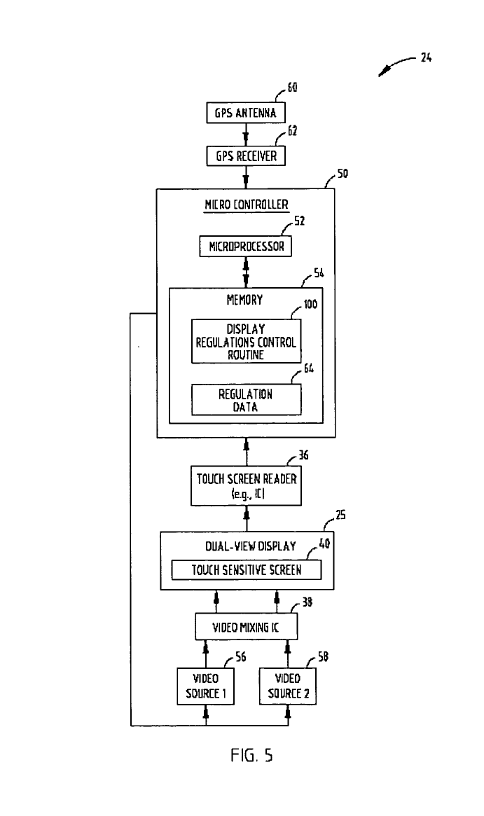

Referring to FIGS. 2 and 3, the infotainment system 20 is further illustrated as seen from the two different viewing windows. In FIG. 2, the display system 24 presents a first image in a first viewing window, such as a navigation map in the first viewing window, for viewing from the left or driver side of the vehicle. In FIG. 3, the display system 24 presents a second image, such as movie video, in the second viewing window for viewing from the right or passenger side of the vehicle. It should be appreciated that the first and second viewing windows presented in FIGS. 2 and 3 may be simultaneously displayed on the display system 24 to provide different image content to the separate viewing windows.

The display system 24 may simultaneously present images to both the driver and passenger of the vehicle 10. However, the display system is controlled to provide features, such as whether to display certain image content, based on regulations imposed in various geographic regions. Whenever the vehicle is located in a geographic region where a requested display feature is in compliance with local rules, such as regulations, the requested display feature is enabled. Whenever the vehicle 10 travels into a geographic location in which the requested display feature is not in compliance with rules (e.g., regulations), the display system disables the feature, such as to prohibit display of video image content. When this occurs, the display system 20 may display a message as seen in FIG. 4 which provides that the image content is available in this state, according to one example.

The HMI of the infotainment system 20 is shown in FIGS. 1-4 including various user manipulatable input controls 26 that may include pushbutton, rotary dial and other user actuated input controls. Additionally, the display system 24 includes touch screen user inputs on a touch sensitive display screen. The touch screen user inputs are user manipulatable such that a user may touch the touch sensitive screen to input commands to the display system 24.

Referring to FIG. 5, the display system 24 according to one embodiment is generally illustrated having a dual-view display 25 with touch sensitive screen 40, and a host microcontroller 50. The host microcontroller 50 includes a microprocessor 52 and memory 54.

Memory 54 contains rules, shown as regulation data 64, which may include government imposed regulations, such as legislative laws, that define the legality of one or more features and the geographic regions in which the laws are in effect. The regulation data 64 may be stored in a look-up table as codes which map the regulation data to corresponding geographic regions. For example, state government imposed laws that regulate certain display features may be mapped with the corresponding states, federal government imposed regulations may be mapped with the corresponding countries, and county government imposed ordinances may be mapped with the corresponding counties. It should be appreciated that other rules may be stored in memory, such as vehicle manufacturer imposed rules or user defined rules.

Also stored in memory 54 is a display regulations control routine 100 which processes the regulation data 64 and, based upon the determined geographic location, controls the electronic device, such as the dual-view display, in compliance with the regulation data 64. The display control routine 100 monitors the location of the vehicle and geographic regulations imposed in various geographic jurisdictions, and determines the control features, available with the display based on the location of the vehicle. Other routines and data may be stored within memory and executed by microprocessor 52. It should be appreciated that the host microcontroller 50 may include a dedicated controller or may be a shared controller performing any of a number of other functions.

The display system 24 also includes video mixing integrated circuitry (IC) 38 and first and second video sources 56 and 58. The first video source 56 generates signals for a first video image containing the first image content. The second video source 58 generates signals for a second video image containing the second image content. The video mixing integrated circuitry 38 receives the signals with the first and second image contents and provides the first and second image contents to the dual-view display 25 to be displayed in the first and second viewing windows, respectively.

The display system 24 further includes a touch screen reader 36 for detecting user manipulation of the touch sensitive screen 40. The touch screen reader 36 may be implemented as integrated circuitry (IC) or other known user input sensing device. The touch sensitive screen 40 allows the user to manipulate “soft” buttons that are displayed on the display screen. Examples of “soft” buttons may include navigation map centering functions, AM/FM radio functions/presets and other feature menu items.

The touch sensitive screen 40 may include a resistive panel according to one embodiment, wherein the touch screen reader 36 determines the location where the user finger is pressing against the screen. The touch screen reader 36 may include an integrated circuit configured to read the X and Y coordinates of the sensed pressure point on the screen and forward the X and Y coordinate information to the host microcontroller 50 for processing therein. Alternately, the touch screen reader 36 may be implemented in software or otherwise configured to sense “soft” buttons on the touch sensitive screen. According to other embodiments, the touch screen reader 36 may include an array of infrared transmitters and receivers that, once the screen 40 is touched or close to being touched, the infrared beam is broken in an X and Y direction and relayed back to the host microcontroller 50.

The display system 24 further includes a global position system (GPS) antenna 60 and a GPS receiver 62 for receiving and processing GPS signals and determining the current geographic location of the display system 24. The GPS receiver processes the received GPS signals to determine the latitude and longitude position coordinates, as is well known. It should be appreciated that any position determining device may be employed to determine the current geographic location.

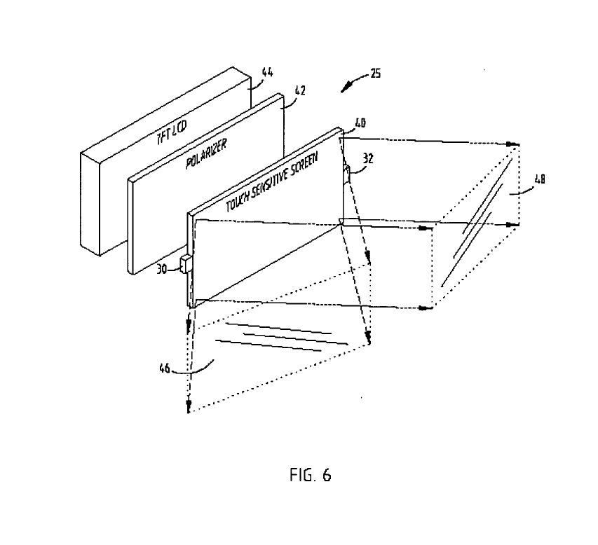

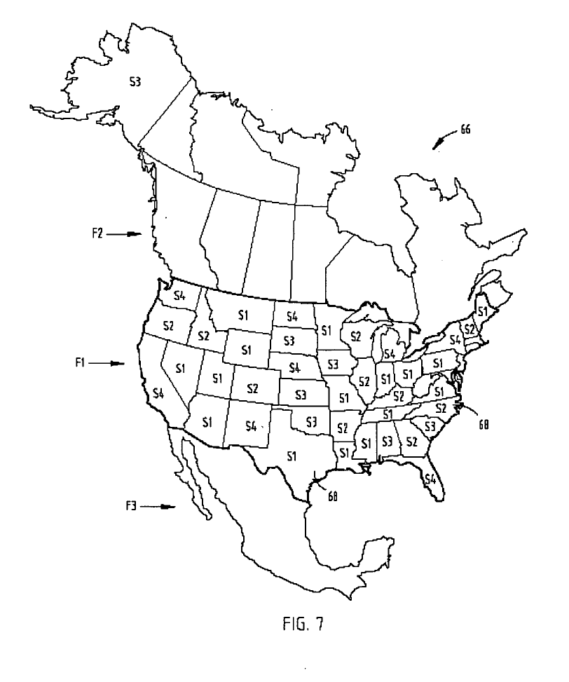

Referring to FIG. 6, one example of a dual-view display 24 is illustrated having an overlaying touch sensitive screen 40. Proximity sensors 30 and 32 are shown mounted on the left and right sides of the touch sensitive screen 40. The left and right capacitive sensors 30 and 32 may detect which user (e.g., driver or passenger) is interfacing with inputs. The dual-view display 25 has a thin film transistor (TFT) liquid crystal display (LCD) 44, according to one embodiment. The LCD 44 generally includes a backlight and transistors configured to control the video pixels. Additionally, the dual-view display 25 includes a polarizer 42 disposed in front of the LCD 44 to cause the light from the backlight of the LCD 44 to separate into right and left directions within the first and second viewing windows. According to one example, the polarizer 42 may include a parallax barrier superimposed on the LCD 44. The resulting dual-view display 25 allows the first and second video images provided by video sources 56 and 58 to be presented on the LCD 44, and directed via polarizer 42 into first and second viewing windows shown by arrows 46 and 48.

One example of a dual-view display is disclosed in U.S. application Ser. No. 11/434,546 filed on May 15, 2006, which is hereby incorporated herein by reference. The dual-view display 25 may include a seven inch (7″) dual view display produced by Sharp Corporation. The use of a dual-view display in a vehicle is known in the art. It should be appreciated that other types of displays may be employed to provide the dual-view image content. It should further be appreciated that other types of displays that include single or more than two image view windows may be employed. For example, the display disclosed in U.S. Patent Application Publication No. 2005/0179827, filed on Feb. 17, 2004, which discloses a display system having electronically controlled viewing window that may change the size of the window from passenger viewing only to both passenger and driver viewing. The aforementioned published patent application is also hereby incorporated herein by reference.

The regulation data 64 may be mapped with rules defined by codes according to geographic regions as seen in FIG. 7, according to one example. The map 66 in FIG. 7 illustrates the continental North America including the countries of the United States, Canada and Mexico, according to one example. Each country has federal government regulations designated by F1-F3 which provide regulations in the form of laws in effect within the corresponding countries. Within a country, such as the United States, the geographic regions may further be broken into smaller geographic regions illustrated as states, each of which may have state government imposed regulations that control one or more features of an electronic device, such as a display. For example, some states may include one set of state government imposed laws shown as laws S1 whereas other states may impose different laws shown as laws S2, laws S3 or laws S4. According to one example of the dual-view display, the laws S1 imposed in some states may regulate one or more features of the dual-view display such that the dual-view display is prohibited from use forward of the driver's seat, whereas another state may impose laws S2 in which the dual-view display may not be visible from the driver's seat, whereas other states may impose laws S3 in which the dual-view display may be visible only in the rear seat, and yet further states may impose laws S4 in which the dual-view display may not be forward of or visible from the driver's seat.

By mapping the various rules, such as regulations, in the regulation data, the display system is able to provide enhanced display functionality made available to passengers in a vehicle in compliance with the geographically imposed regulations. For example, when a vehicle 10 travels from one geographic region having a state law S1 into a second geographic region having a state law S2, the display system automatically detects the change in geographic jurisdiction and controls the dual-view display to ensure that the features are used in compliance with the mandated regulations of the current geographic region. It should further be appreciated that smaller regions, such as counties, may be mapped with county government imposed ordinances.

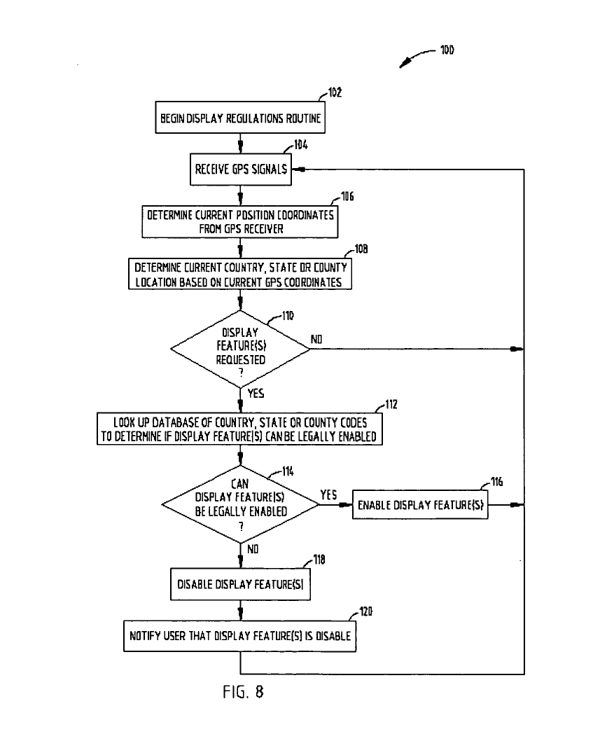

Referring to FIG. 8, the display regulations control routine 100 is illustrated according to one embodiment of the present invention. The routine 100 begins at step 102 and proceeds to receive GPS signals in step 104. Next, routine 100 determines the current position (location) in the form of latitude and longitude position coordinates, from the GPS receiver in step 106. Once the GPS position coordinates are known, the routine 100 determines the current country, state or county location based on the current GPS coordinates in step 108.

The display regulations control routine 100 determines whether display features have been requested in step 110. For example, the display features requested may include a passenger requesting display of images in the form of movie video, or other data. If no display features are requested, the routine 100 returns to step 104. If one or more display features have been requested, routine 100 proceeds to step 112 to look up the database of the country, state or county codes to determine if the display feature(s) can be legally enabled in compliance with the imposed regulations. Once the regulation data for the geographic region (country, state or county) is determined, routine 100 determines in step 114 if the display feature(s) can be legally enabled in compliance with the regulation data. If the display feature(s) can be legally enabled, routine 100 proceeds to enable the display feature(s) in step 116, and then returns to step 104. If routine 100 determines that the display feature(s) cannot be legally enabled, routine 100 proceeds to disable the requested display feature(s) in step 118, and then notifies the user that the display feature(s) is disabled in step 120, before returning to step 104. Accordingly, the display regulations control routine 100 regulates the display features that may be available based upon the geographic location and regulations imposed in such location.

Accordingly, the display system 24 and method 100 of the present invention advantageously allows for use of an electronics device in compliance with geographically imposed rules. This allows for users to achieve optimum use of the electronics device as the vehicle 10 travels amongst various geographic jurisdictions. While the present invention has been described herein in connection with a dual-view display 24, it should be appreciated that the system and method of ensuring compliance with geographically imposed rules may be applicable to other electronic devices such as cell phones. Additionally, it should be appreciated that rules described herein may include regulations, laws, statutes, ordinances, common laws and other rules that are imposed based upon geographic location.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. An electronics system providing one or more features in compliance with geographically imposed rules, said electronics system comprising:
an electronic device operable to provide one or more features;
a device for acquiring rules pertaining to use of the electronic device based on geographic regions;
a position determining device for determining geographic location of the electronic device; and
a controller for controlling the electronic device, wherein the controller looks up rules pertaining to the determined geographic location and controls one or more features of the electronic device based on the rules pertaining to the determined geographic location.

2. The electronics system as defined in claim 1, wherein the electronic device is employed onboard a vehicle.

3. The electronics system as defined in claim 1, wherein the electronic device comprises a display for presenting an image having image content that is viewable within a viewing window.

4. The electronics system as defined in claim 3, wherein the display comprises a dual-view display for presenting first and second images in first and second viewing windows.

5. The electronics system as defined in claim 4, wherein the dual-view display is employed onboard a vehicle to present first images to a driver of the vehicle within the first viewing window and second images to a passenger in the vehicle within the second viewing window.

6. The electronics system as defined in claim 5, wherein the one or more features controlled by the controller comprise image content made available to at least one of the driver and the passenger in the vehicle.

7. The electronics system as defined in claim 1, wherein the rules comprise at least one of government imposed regulations.

8. The electronics system as defined in claim 1, wherein the device for retrieving the rules comprises a memory storage device containing rules pertaining to multiple geographic regions.

9. The electronics system as defined in claim 1, wherein the position determining device comprises a global positioning system receiver.

10. A display system for displaying image content in a vehicle in compliance with geographically imposed rules, said display system comprising:
a display located in a vehicle for presenting an image having image content that is viewable within a viewing window by one or more passengers in the vehicle;
a device for acquiring rules pertaining to use of the display based on geographic regions;
a position determining device for determining geographic location of the display; and
a controller for controlling the display, wherein the controller retrieves rules pertaining to the determined geographic position and controls one or more display features based on the retrieved rules pertaining to the determined geographic location.

11. The display system as defined in claim 10, wherein the display comprises a dual-view display, wherein the one or more display features controlled by the controller responsive to the rules pertaining to the determined geographic location comprise display of image content made available to at least one of a driver and a passenger in the vehicle.

12. The display system as defined in claim 10, wherein the device for retrieving rules comprises a memory storage device containing rules pertaining to multiple geographic regions.

13. The display system as defined in claim 10, wherein the position determining device comprises a global positioning system receiver.

14. The display system as defined in claim 10, wherein the rules pertain to whether one or more display features can be used in compliance with government imposed regulations.

15. A method of providing one or more features with an electronic device based on rules imposed in geographic regions, said method comprising the steps of:
providing an electronic device operable to provide one or more features;
storing in memory rules pertaining to use of the one or more features based on geographic regions;
determining a geographic location of electronics device;
selecting rules that pertain to the determined geographic location; and
controlling one or more features of electronic device based on the selected rules pertaining to the determined geographic location.

16. The method as defined in claim 15, wherein the step of providing an electronic device comprises providing the electronic device onboard a vehicle.

17. The method as defined in claim 15, wherein the step of providing an electronic device comprises providing a display for presenting an image having image content that is viewable within a viewing window.

18. The method as defined in claim 17, wherein the display comprises a dual-view display for presenting first and second images and first and second viewing windows.

19. The method as defined in claim 18, wherein the dual-view display is located on a vehicle for presenting first and second images to a driver and a passenger in the vehicle within respective first and second viewing windows.

20. The method as defined in claim 19, wherein the one or more features controlled comprise image content made available to at least one of the driver and passenger.

21. The method as defined in claim 15, wherein the step of storing rules comprises storing government imposed regulations.

22. The method as defined in claim 21, wherein the step of selecting rules comprises retrieving rules stored in a memory storage device.

23. A method of presenting display images to one or more users in a vehicle based on rules imposed in geographic regions, said method comprising the steps of:
providing a display in a vehicle for presenting an image having image content that is viewable within a viewing window to a passenger on the vehicle;
storing in memory rules pertaining to use of display features based on geographic regions;
determining a geographic location of the display;
selecting rules that pertain to the determined geographic location; and
controlling one or more display features based on the selected rules pertaining to the determined geographic location.

24. The method as defined in claim 23, wherein the step of providing a display comprises providing a dual-view display and the one or more features comprise the display of image content made available to at least one of a driver and a passenger in the vehicle.

25. The method as defined in claim 23, wherein the step of storing rules comprises storing government imposed regulations that pertain to one or more display features that can be used in compliance with laws.

26. The method as defined in claim 23, wherein the step of determining a current geographic position of the display comprises receiving GPS signals and processing the GPS signals with a GPS receiver to obtain position coordinates.
